(19) United States
(12) Patent Application Publication
(10) Pub. No.: US 2020/0252877 A1
(43) Pub. Date: Aug. 6, 2020

(54) MECHANISM TO ALLOW POWER CONSTRAINED NEIGHBOR AWARENESS NETWORKING DEVICES TO SLEEP

(71) Applicant: Intel IP Corporation, Santa Clara, CA (US)

(72) Inventors: Dibakar Das, Hillsboro, OR (US); Dave Cavalcanti, Portland, OR (US); Po-Kai Huang, San Jose, CA (US); Emily Hong Qi, Gig Harbor, WA (US)

(73) Assignee: Intel IP Corporation, Santa Clara, CA (US)

(21) Appl. No.: 16/652,041

(22) PCT Filed: Dec. 28, 2017
(86) PCT No.: PCT/US2017/068811

§ 371 Date: Mar. 28, 2020

(51) Int. Cl. H04W 52/02; H04W 56/00

(52) U.S. Cl. CPC H04W 52/0277; H04W 84/18; H04W 56/0015

(57) ABSTRACT

Some demonstrative embodiments include apparatuses, devices and/or methods. For example, an apparatus may include a memory, and processing circuitry coupled to the memory. The processing circuitry is configured to execute logic stored in the memory to cause a power-constrained Neighbor Awareness Networking (NAN) Device (PD NAN Device) within a NAN Cluster to transition to a non-synchronization-frame (non-Sync-frame) mode based on a triggering event including at least one of: reception, by a NAN layer of the PD NAN Device, of transition instructions from a Service/Application layer of the PD NAN Device; or reception by the PD NAN Device of a management frame from a non-power-constrained NAN Device (non-PD NAN Device), the management frame including information on the PD NAN Device transitioning to a non-Sync-frame transmitter mode.

### TECHNICAL FIELD

Embodiments described herein generally relate to communicating in a data link group.

### BACKGROUND

In some wireless communication networks, such as in networks including devices compliant with the Wi-Fi Alliance Neighbor Awareness Networking (NAN) protocol, including NAN 2.0, in order for NAN devices to stay synchronized with one another in the same NAN Cluster, such devices must share the same Time Synchronization Function (TSF). In order to achieve TSF timer synchronization, some NAN devices in the cluster must regularly transmit Synchronization (Sync) beacons in each Discovery Window (DW) in order to distribute the TSF within the cluster. However, Sleepy End Devices (SEDs), which are typically power-constrained, such as SEDs within a Thread network (that is, within a network that operates based on the Thread Group Alliance's Thread networking protocol), within a ZigBee network or any other low power network that are not able to operate with minimal possible power consumption when sending Sync beacons to allow TSF synchronization within the NAN network.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is an illustration of a Neighbor Awareness Networking (NAN) Multicast Service Group (NMSG) environment;

FIG. 2 is a diagram of a NAN Device according to an embodiment;

FIG. 3a is a diagram of a NAN Multicast Service Group (NMSG) including some NAN Devices that are out of range with one another;

FIG. 3b is an illustrative table for a Remaining Energy Level field in the NAN protocol;

FIG. 4 is a diagram showing a data flow between two NAN Devices according to some demonstrative embodiments;

FIG. 5a is a flow-chart illustration of a method according to some demonstrative embodiments;

FIG. 5b is a flow-chart illustration of a method according to some other demonstrative embodiments; and

FIG. 6 is a schematic illustration of a product in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with devices and/or networks operating in accordance with existing Wireless Fidelity (Wi-Fi) Alliance (WFA) Specifications (including WFA Neighbor Awareness Networking (NAN) Specifications) and/or future versions and/or derivatives thereof, devices and/or networks operating in accordance with existing WFA Peer-to-Peer (P2P) specifications (Wi-Fi P2P technical specification, version 1.2, 2012) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); and/or IEEE-802.11REVmc (“IEEE 802.11—REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”)) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra-Red (IR), Frequency-Division Multiplexing (FUM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless communication device,” as used herein, includes, for example, a device capable of wireless communication (such as, for example, a baseband processor, a wireless circuit card, a system-on-a-chip (SoC) including a wireless circuit card and a radio front-end module (FEM), or a SoC including a baseband processor, a radio integrated circuit, a FEM and an application processor), a communication system capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a wireless fidelity (Wi-Fi) network. Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The term “station” (STA) or NAN Device, as used herein, may include any logical entity that is a singly addressable instance of a medium access control (MAC) and a physical layer (PHY) interface to a wireless medium (WM).

The phrase “peer to peer (PTP) communication”, as used herein, may relate to device-to-device communication over a wireless link (“peer-to-peer link”) between devices. The PTP communication may include, for example, a Wi-Fi Direct (WFD) communication, e.g., a WFD Peer to Peer (P2P) communication, wireless communication over a direct link within a QoS basic service set (BSS), a tunneled direct-link setup (TDLS) link, a STA-to-STA communication in an independent basic service set (IBSS), or the like.

Some demonstrative embodiments are described herein with respect to Wi-Fi communication. However, other embodiments may be implemented with respect to any other communication scheme, network, standard and/or protocol.

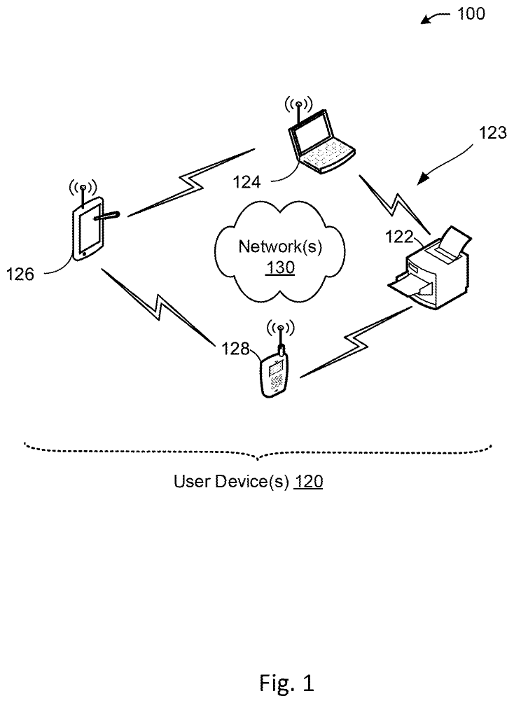

Reference is now made to FIG. 1, which schematically illustrates a block diagram of a NAN environment 100 including a wireless network 130 in accordance with some demonstrative embodiments. NAN environment 100 may include one or more wireless communication devices or NAN Devices 120, e.g., wireless communication devices 122-128. Wireless communication devices 120 may include, for example, a User Equipment (UE), an Mobile Device, a STA, an Access Point, a Personal Computer, a desktop computer, a mobile computer, a laptop computer, an Ultrabook™ computer, a notebook computer, a tablet computer, a server computer, a handheld computer, a handheld device, an Internet of Things (IoT) device, a Personal Digital Assistance (PDA) device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

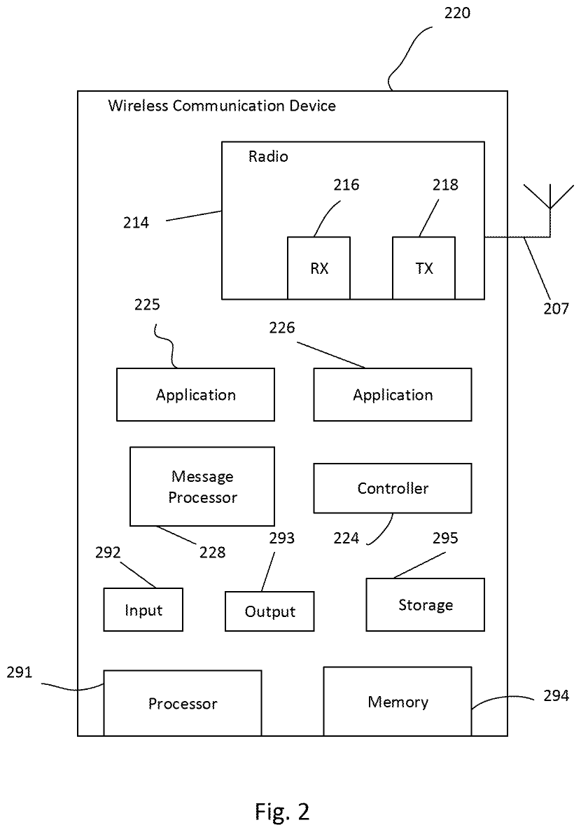

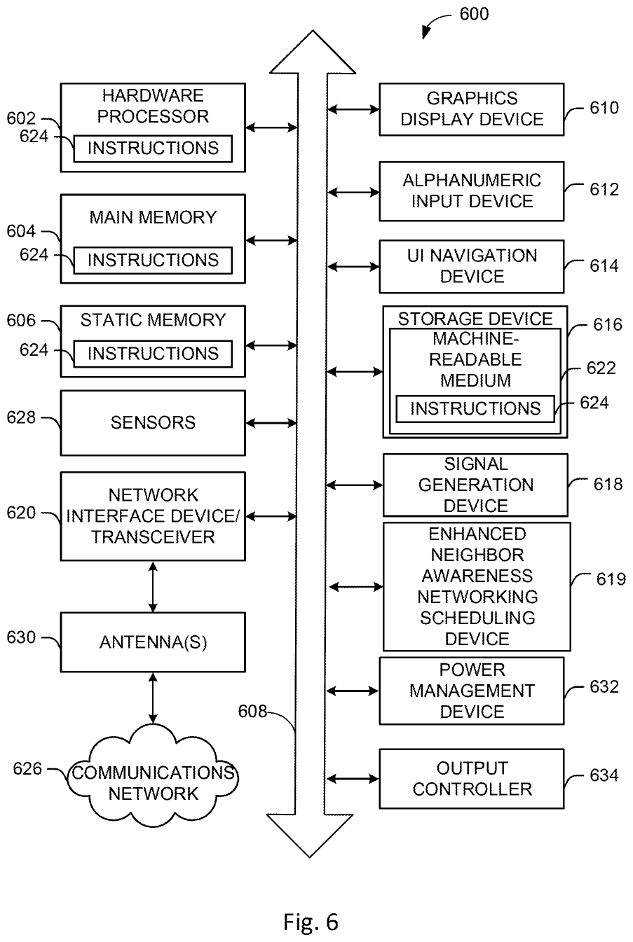

In some demonstrative embodiments, devices 120 may include, for example, processing circuitry, an input unit, an output unit, a memory, and a storage unit. In some embodiments, devices 120 may include one or more computer systems similar to that of the functional diagram of FIG. 2 and/or the example machine/system of FIG. 6, which are described in further detail below.

In some demonstrative embodiments, devices 120 may be capable of communicating content, data, information and/or signals via a wireless medium (WM). In some demonstrative embodiments, the wireless medium to be used by devices 120 may, for example, include a radio channel, a cellular channel, a Global Navigation Satellite System (GNSS) Channel, an RF channel, a Wireless Fidelity (Wi-Fi) channel, an IR channel, a Bluetooth (BT) channel, and the like. The wireless medium 123 may include a wireless communication channel over a 2.4 Gigahertz (GHz) frequency band, a 5 GHz frequency band, a millimeterWave (mmWave) frequency band, e.g., a 60 GHz frequency band, a Sub 1 Gigahertz (S1G) band, and/or any other frequency band.

In some demonstrative embodiments, wireless communication devices 120 may form, and/or may communicate as part of, a wireless local area network (WLAN). In some demonstrative embodiments, wireless communication devices 120 may form, and/or may communicate as part of, a Wi-Fi network. In some demonstrative embodiments, wireless communication devices 120 may form, and/or may communicate as part of, a Wi-Fi Direct (WFD) network, e.g., a Wi-Fi direct services (WFDS) network, and/or may perform the functionality of one or more WFD devices. In one example, devices 120 may include, or may perform the functionality of a Wi-Fi Direct device.

In some demonstrative embodiments, wireless communication devices 120 may be capable of performing awareness networking communications, for example, according to an awareness protocol, e.g., a NAN protocol, a Wi-Fi Aware protocol or a Social Wi-Fi protocol as administered by the Wi-Fi Alliance, and/or any other protocol, e.g., as described below. In some demonstrative embodiments, wireless communication devices 120 may include an awareness networking device and/or station. For example, wireless communication devices 120 may be capable of forming, and/or communicating as part of, a Neighbor Awareness Networking (NAN) network as administered by the Wi-Fi Alliance, e.g., a Wi-Fi NAN, and/or may perform the functionality of one or more NAN Devices. In some demonstrative embodiments, wireless communication devices 120 may include a NAN Device and/or station. A “NAN Device” as used herein refers to a device that is to be compliant with any of the NAN protocol specifications.

In some demonstrative embodiments, the wireless medium may include a direct link, for example, a PTP link, e.g., a Wi-Fi direct P2P link, for example, to enable direct communication between devices 120.

In some demonstrative embodiments, wireless communication devices 120 may perform the functionality of WFD P2P devices. For example, devices 120 may be able to perform the functionality of a P2P client device, and/or P2P group Owner (GO) device.

In other embodiments, wireless communication devices 120 may form, and/or communicate as part of, any other network and/or perform the functionality of any other wireless devices or stations.

Referring next to FIG. 2, according to some demonstrative embodiments, a device 220, which may represent one of devices 120 of FIG. 1, may include one or more applications 225 and 226 configured to provide, share, and/or to use one or more services, e.g., a social application, a file sharing application, a media application and/or the like, for example, using an awareness network, NAN network, a PTP network, a P2P network, WFD network, or any other network.

In some demonstrative embodiments, device 220 may be capable of sharing, showing, sending, transferring, printing, outputting, providing, synchronizing, and/or exchanging content, data, and/or information, e.g., between various applications.

In some demonstrative embodiments, device 220 may include, for example, one or more of a processor 291, an input unit 292, an output unit 293, a memory 294, and a storage unit 295. Device 220 may optionally include other suitable hardware components and/or software components. In some demonstrative embodiments, some or all of the components of one or more of device 220 may be enclosed in a common housing or packaging, and may be interconnected or operably associated using one or more wired or wireless links. In other embodiments, components of one or more of device 220 may be distributed among multiple or separate devices.

Processor 291 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 291 is to execute instructions, for example, of an Operating System (OS) of device 220 and/or of one or more suitable applications.

According to some embodiments, a processing circuitry of NAN Device 220 may include one or more of processor 291, message processor 228, or controller 224. The processing circuitry or any part thereof may be implemented in one or more of a baseband processor or an application processor of the NAN Device.

Input unit 292 includes, for example, a keyboard, a keypad, a mouse, a touch-screen, a touch-pad, a track-ball, a stylus, a microphone, or other suitable pointing device or input device. Output unit 293 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

Memory 294 includes, for example, a Random-Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short-term memory, a long-term memory, or other suitable memories. Storage unit 295 and/or storage unit 295 includes, for example, a hard disk drive, a floppy disk drive, a Compact Disk (CD) drive, a CD-ROM drive, a DVD drive, or other suitable removable or non-removable storage units. Memory 294 and/or storage unit 295, for example, may store data processed by device 220.

In some demonstrative embodiments, wireless communication device 220 may be capable of communicating content, data, information and/or signals via a wireless medium (WM), such as wireless medium 123 of FIG. 1. In some demonstrative embodiments, the wireless medium may include, for example, a radio channel, a cellular channel, a Global Navigation Satellite System (GNSS) Channel, an RF channel, a Wireless Fidelity (Wi-Fi) channel, an IR channel, a Bluetooth (BT) channel, and the like. In some demonstrative embodiments, the wireless medium may include a wireless communication channel over a sub 1 Gigahertz (GHz) (S1G) frequency band. In some demonstrative embodiments, device 220 may be configured to communicate over the S1G band, e.g., as described below. Additionally, or alternatively, the wireless medium may include a wireless communication channel over a 2.4 GHz frequency band, a 5 GHz frequency band, a millimeterWave (mmWave) frequency band, e.g., a 60 GHz frequency band, and/or any other frequency band.

In some demonstrative embodiments, device 220 may include one or more radios 214 including circuitry and/or logic to perform wireless communication. Radio 214 may include one or more wireless receivers (Rx) including circuitry and/or logic to receive wireless communication signals, RF signals, frames, blocks, transmission streams, packets, messages, data items, and/or data. For example, radio 214 may include a receiver 216. Radio 214 may include one or more wireless transmitters (Tx) including circuitry and/or logic to send wireless communication signals, RF signals, frames, blocks, transmission streams, packets, messages, data items, and/or data. For example, radio 214 may include a transmitter 218. Radio 214 may further include circuitry and/or logic, modulation elements, demodulation elements, amplifiers, analog to digital and digital to analog converters, filters, and/or the like. In one example, radio 214 may include or may be implemented as part of a wireless Network Interface Card (NIC), and the like. Radio 214 may further include, or may be associated with, one or more antennas 207.

Antenna 207 may include any type of antenna suitable to transmit and/or receive wireless communication signals, blocks, frames, transmission streams, packets, messages and/or data. Antenna 207 may include any suitable configuration, structure and/or arrangement of one or more antenna elements, components, units, assemblies and/or arrays. Antennas 207 may further include, for example, an antenna suitable for directional communication, e.g., using beamforming techniques, such as a phased array antenna, a multiple element antenna, a set of switched beam antennas, and/or the like. In some embodiments, antenna 207 may implement transmit and receive functionalities using separate transmit and receive antenna elements. In some embodiments, antenna 207 may implement transmit and receive functionalities using common and/or integrated transmit/receive elements.

In some demonstrative embodiments, wireless communication device 220 may be part of, or may form, a wireless local area network (WLAN). In some demonstrative embodiments, wireless communication device 220 may be part of, or may form, a Wi-Fi network. In some demonstrative embodiments, wireless communication device 220 may be part of, or may form, a Wi-Fi Direct (WFD) network, e.g., a Wi-Fi direct services (WFDS) network, and/or may perform the functionality of one or more WFD devices. In one example, device 220 may include, or may perform the functionality of a Wi-Fi Direct device.

In some demonstrative embodiments, wireless communication device may be capable of performing awareness networking communications, for example, according to an awareness protocol, e.g., a Wi-Fi Aware protocol, A Social Wi-Fi protocol, a Neighbor Awareness Networking (NAN) protocol, and/or any other protocol, e.g., as described below.

In some demonstrative embodiments, the wireless medium may include a direct link, for example, a PTP link, e.g., a Wi-Fi direct P2P link, for example, to enable direct communication between devices.

In some demonstrative embodiments, wireless communication device 220 may perform the functionality of WFD P2P devices. For example, device 220 may be able to perform the functionality of a P2P client device, and/or P2P group Owner (GO) device.

In other embodiments, wireless communication device 220 may form, and/or communicate as part of, any other network, and/or may perform the functionality of any other wireless devices or stations.

In some demonstrative embodiments, device 220 may include one or more applications configured to provide, share, and/or to use one or more services, e.g., a social application, a file sharing application, a media application and/or the like, for example, using a NAN network, a PTP network, a P2P network, WFD network, or any other network.

In some demonstrative embodiments, device 220 may execute an application 225 and/or an application 226, and may be configured to execute these applications.

In some demonstrative embodiments, device 220 may be capable of sharing, showing, sending, transferring, printing, outputting, providing, synchronizing, and/or exchanging content, data, and/or information, e.g., between application 225 and applications 226.

In some demonstrative embodiments, device 220 may include a controller configured to control one or more functionalities of device 220, for example, one or more functionalities of communication, e.g., communication over the S1G, NAN communication and/or any other communication, between device 220 and/or other devices, and/or any other functionality, e.g., as described below. For example, device 220 may include a controller 224.

In some demonstrative embodiments, controller 224 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of controller 224. Additionally or alternatively, one or more functionalities of controller 224 may be implemented by logic, which may be executed by a machine and/or one or more processors, e.g., as described below. In one example, controller 224 may include one or more processors having circuitry and/or logic to cause a device or a station, e.g., device 220, to perform one or more functionalities, e.g., as described herein.

In one example, controller 224 may include one or more processors including circuitry and/or logic to cause a wireless device, e.g., device 220, and/or a wireless station, e.g., a wireless STA implemented by device 220, to perform one or more operations, communications and/or functionalities, e.g., as described herein.

In some demonstrative embodiments, device 220 may include a message processor 228 configured to generate, process and/or access one or messages communicated by device 220. In one example, message processor 228 may be configured to generate one or more messages to be transmitted by device 220, and/or message processor 228 may be configured to access and/or to process one or more messages received by device 220, e.g., as described below.

In some demonstrative embodiments, message processor 228 may include circuitry, e.g., processor circuitry, memory circuitry, Media-Access Control (MAC) circuitry, Physical Layer (PHY) circuitry, and/or any other circuitry, configured to perform the functionality of message processor 228. Additionally or alternatively, one or more functionalities of message processor 228 may be implemented by logic, which may be executed by a machine and/or one or more processors, e.g., as described below. In some demonstrative embodiments, at least part of the functionality of message processor 128 may be implemented as part of radio 214. In some demonstrative embodiments, at least part of the functionality of message processor 228 may be implemented as part of controller 224. In other embodiments, the functionality of message processor 228 may be implemented as part of any other element of device 220.

In some demonstrative embodiments, device 220 may perform the functionality of a device or station, for example, a S1G device and/or STA, a NAN Device and/or station, a Wi-Fi device and/or station, a WFD device and/or station, a WLAN device and/or station, and/or any other device and/or station, capable of discovering other devices and/or stations according to a discovery protocol and/or scheme.

In some demonstrative embodiments, radio 214 may communicate over the wireless medium according to an awareness networking scheme. In some demonstrative embodiments, the awareness networking scheme may include, for example, a discovery scheme, for example, a NAN discovery scheme, or any other awareness networking and/or discovery scheme, e.g., as described below. In some demonstrative embodiments, device 220 may perform a discovery process according to the discovery scheme using a discovery window (DW), for example, to discover each other, and/or to establish a wireless communication link, e.g., directional and/or high throughput wireless communication link.

In some demonstrative embodiments, device 220 may be configured to enable time synchronization between itself and one or more other devices, e.g., performing the functionality of Wi-Fi stations (STAs), for example, such that STAs can discover each other more efficiently and/or quickly.

The Wi-Fi Aware NAN 2.0 protocol (NAN 2.0) allows multiple devices to communicate amongst themselves in a power-efficient manner. Devices are configured to transmit or receive data in specific time-frequency blocks (which may be negotiated), and can sleep otherwise. Because of power-efficiency, NAN provides an appealing technology for Internet-of-Things (IoT) scenarios. By way of example, devices requiring higher data throughput or larger network coverage may use NAN as the medium access control (MAC) scheme instead of using IEEE 802.15.4 while the same time using typical IoT routing protocols (e.g. the Routing Protocol for Low power and Lossy Networks (RPL) or the Thread protocol) in the upper layers.

In the NAN 2.0 scheme, each NAN device in a NAN Cluster shares the same Time synchronization function (TSF) as dictated by a node called the Anchor Master (AM). There is only one Anchor Master per NAN Cluster. Devices distribute the TSF of the Anchor Master by transmitting Synchronization (Sync) beacons in each Discovery Window (DW). The Sync beacons in each Discovery Window are repeated every 512 Time Units (TU). NAN devices assume beacon transmission roles in a distributed fashion, according to which a NAN device transmits a Sync beacon if it is in a Non-Master Sync role or in a Master role. Whether a NAN device is either in a Non-Master Sync role or in a Master role will depend on its relative location with respect to another beacon transmitting NAN device, and the number of hops from the Anchor Master. If a NAN device is in a Non-Master Non-Sync role, it will not transmit any beacons and may go to sleep in certain DWs (not including DW0).

IoT networks typically include heterogenous devices having different capabilities, such as different power capabilities. For instance, Thread or RPL networks may contain SEDs and routers. While SEDs are not able to forward traffic, and can only communicate with their parent nodes, routers on the other hand can forward traffic to each other as well as to other SEDs. Within the NAN protocol, beacon transmission provides the main NAN management function to be supported by all NAN devices, meaning that, in a network including the SEDs where NAN is being used as the MAC scheme, according to the state of the art, a SED would need to transmit Sync beacons when it is either in a Non-Master Sync role or in a Master role in order to ensure TSF synchronization in compliance with NAN. According to the above scheme, however, a SED device would not be able to operate with minimal possible power consumption, and would likely violate its own power restrictions.

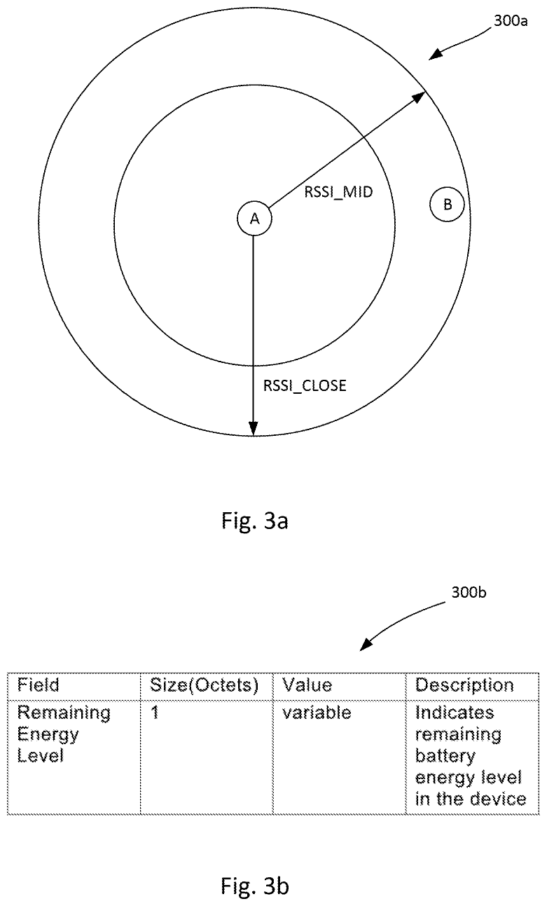

Reference is now made to FIG. 3a, which shows a network environment 300a including devices A and B using NAN as their MAC communication scheme. The description of FIG. 3a to follow provides an example of the limitation of current NAN Sync beacon transmission schemes as suggested in the paragraphs above. In particular, in FIG. 3a, device A is a power-constrained device such as a SED that is configured to communicate with the rest of the network via a non-power-constrained device B. For example, device B may include a layer-3 router device under a Thread or RPL routing protocol while device A may be a SED. Under the current NAN specification, A is to transmit a Sync beacon if the Relative Received Signal Strength Indication (RSSI) of a Sync beacon that device A receives from device B is below a value of RSSI_close, and the RSSI of a Sync beacons that device A receives from other nodes is below RSSI_middle. The NAN protocol sets the value for RSSI_close to be greater than −60 dBm and for RSSI_middle shall be greater than −75 dBm and less than the value defined for RSSI_close. Therefore, if the RSSI of Sync beacons received from B is outside the noted limit of RSSI_close, A, although it is a SED, will be forced under the NAN regime to transmit Sync beacons to ensure TSF synchronization. It is true that the above problem may be surmounted by moving A and B close to one another. However, the latter is not always practical, and may in some instances require a detailed knowledge of the network topology, which is not possible in many cases. In addition, the network topology may change during operation, such as, for example, in an instance where a router may change its role to that of a SED node, for example as a result of power depletion. Thus, moving A and B close to one another may not present a robust enough solution for large networks and practical application deployments.

A situation such as the one described in relation to FIG. 3a may disadvantageously lead to power depletion of SED devices in networks that use NAN as their MAC scheme, such as, for example, Thread or RPL protocol networks.

Embodiments advantageously provide a solution according to which a power-constrained NAN device may operate in a SED role without transmitting some NAN management frames, such as Sync beacons, and may further maintain synchronization with the NAN Cluster in a power-efficient manner. Hereinafter, a power-constrained NAN device that is to operate as a SED will be referred to as “PD.” According to some demonstrative embodiments, mechanisms may be provided that allow some PDs that are part of a NAN Cluster to not participate in NAN beacon transmissions. In order for the PDs to remain synchronized based on the NAN Cluster TSF, according to some demonstrative embodiments, some non-PD NAN Devices (NAN devices that are not power-constrained) may transmit Sync beacons even if they are not in a Master role or in a Non-Master Sync role in NAN slots. Such slots may be negotiated and may in some instances not correspond to a DW.

Embodiments expand the scope of the current NAN 2.0 beacon transmission scheme by allowing more power savings and therefore by facilitating operation of PD's in IoT networks. Some demonstrative embodiments allow PDs to potentially never assume the role of a Sync beacon transmitter, thus saving considerable power. NAN 2.0 currently allows individual device capabilities in its distributed beacon transmission scheme by allowing each NAN device to specify its individual device capabilities preference inside a beacon frame. However, such a scheme does not guarantee desirable results, as demonstrated by the example of FIG. 1 described above. According to the state of the art, a NAN Device that has indicated its device capabilities preference (e.g. its Master Preference indicated in the Master Indication Attribute sent by the NAN Device) in a manner that would suggest it ought not become a synchronization beacon transmitter (e.g. if it is a power-constrained NAN Device), it may still be forced to assume that role if device capabilities preferences of other devices are lower. The NAN 2.0 beacon transmission rule has as its main goal the maximization of NAN Cluster discovery and the maintenance of TSF synchronization within a cluster, and not the facilitation of minimal power consumption for certain devices. By allowing PDs to listen for beacons in specific NAN slots, some demonstrative embodiments allow PDs to remain synchronized while reducing idle power consumption.

In some demonstrative embodiments, according to a first aspect, a PD NAN Device may transition to a non-Sync-frame transmitter mode (that is, a role in which the PD NAN Device does not transmit any Sync frames, such as any Sync beacon frames, that have as their purpose to Sync the PD NAN Device within its NAN Cluster with respect to the TSF existing within that cluster). According to one embodiment the PD NAN Device may transition to a non-Sync-frame transmitter mode based on a triggering event, and may then Sync its TSF to the NAN Cluster based on communications with a non-PD NAN Device.

According to one embodiment, the triggering event may include reception, by the NAN layer of the PD NAN Device, of transition instructions from a service or application (Service/Application) layer of the PD NAN Device in response to a determination by the Service/Application layer of the PD NAN Device that the PD NAN Device is power-constrained. For example, the Service/Application layer may determine that the PD NAN Device is a power-constrained SED (PD). The Service/Application layer may in one embodiment determine that the PD NAN Device is power-constrained by determining its remaining battery energy, its capabilities (e.g. whether or not it is a router), its application configuration and/or other system parameters suggesting that the PD NAN Device is power constrained. According to another embodiment, the triggering event may include a transitioning of the PD NAN Device to a Sleepy Edge Device (SED) or to a child device in a layer-3 topology under a layer-3 routing protocol such as RPL or Thread.

In the alternative, the trigger event may include the PD NAN Device receiving a management frame indicating that the PD NAN Device may transition to a non-Sync-frame transmitter role. For example, the management frame may include a beacon. According to an embodiment, the management frame may include triggering information indicating that all PDs participating in the NAN Cluster including the PD NAN Device may transition to a non-Sync-frame transmitter role. By way of example, the management frame may be transmitted by an Anchor Master of the NAN Cluster, and the triggering information may include a bit in the management frame, such as, for example, a bit in a currently existing field in a beacon frame, or in a new field in a beacon frame (where the management frame includes a beacon frame).

According to another embodiment, the triggering event may include the PD NAN Device setting up a NAN Data Path with another non-PD NAN Device. According to one alternative, the non-PD NAN Device may include the PD NAN Device's parent node in a layer 3 topology. For example, upper layers of the PD NAN Device, such as the Service/Application layer, may instruct the NAN layer of the PD NAN Device to include switching information in corresponding NAN Data Path setup request frames indicating that the PD NAN Device is a PD and needs to switch to a non-Sync-frame transmitter role. By way of example, the switching information may be contained in one or more bits in an existing attribute or field in a NAN frame, or in a new attribute or field in a NAN frame, for example in a NAN Action Frame (NAF) representing a NAN Data Path setup request. By way of example, the PD NAN Device may use the reserved bit 3 in the capabilities field in the device capability attribute in a NAN Data Path set up request NAF to a first value, such as 1 or 0, indicating that it wishes to switch to a non-Sync-frame transmitter role. A second value of bit 3 would then otherwise be set to 0 or 1.

When the triggering event includes the PD NAN Device setting up a NAN Data Path with another non-PD NAN Device, another alternative includes the PD NAN Device sending information regarding one or more of its system configuration parameters in the NAN data path setup request NAF. Such system configuration parameters may for example include battery power level, device capabilities, device rank, or other parameters). Such information may for example be included in an existing attribute or field in the NAN Data Path setup request NAF, for instance by using the reserved bits 4-7 in the capabilities field in the device capability attribute to indicate a remaining energy level in the PD NAN Device. Alternatively, such information may be included in a new attribute or field in the NAN Data Path setup request NAF.

Reference is now made to FIG. 3b which shows a table 300b in the context of an embodiment where the triggering event includes the PD NAN Device setting up a NAN Data Path with another non-PD NAN Device, where the PD NAN Device is to send information regarding one or more of its system configuration parameters in the NAN data path setup request NAF. Such information may for example be included in a Remaining Energy Level field as shown in table 300b, the Remaining Energy Level field having for example a size of 1 octet, with a variable value, and indicating a remaining battery energy level in the device. This new attribute or field may for example be similar to the Battery Level TLV in Thread.

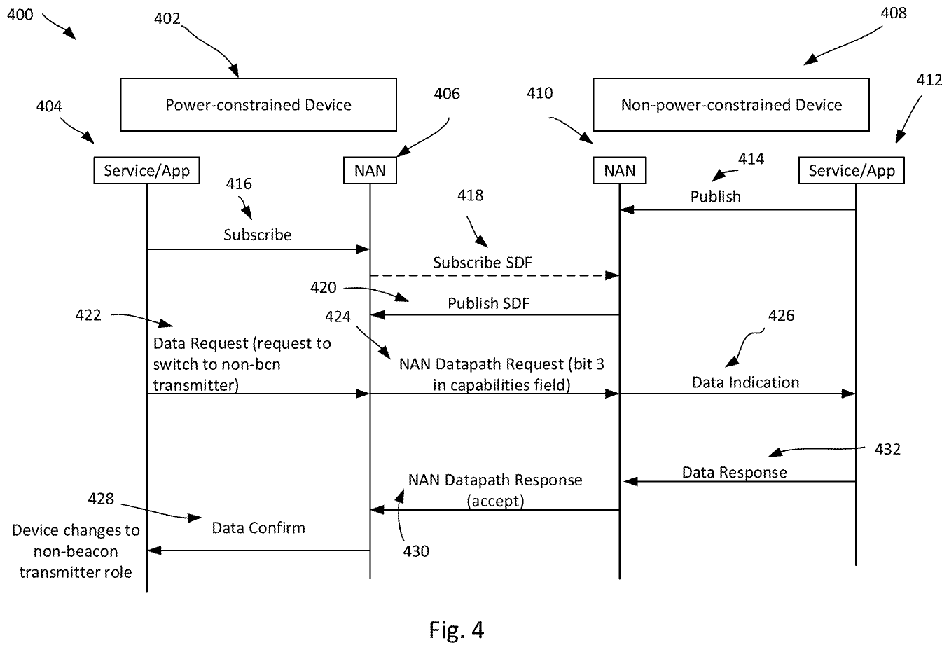

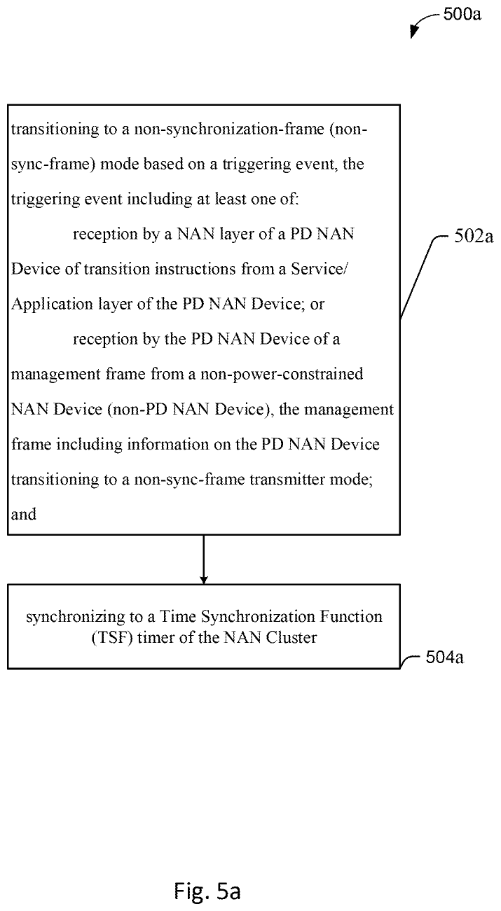

With respect to the embodiment where the triggering event includes the PD NAN Device setting up a NAN Data Path with another non-PD NAN Device, reference is now made to FIG. 4, which shows a data flow 400 for respective ones of NAN Devices 402 and 408. NAN Device 402 is a power-constrained NAN Device, a PD NAN Device, which includes a Service/Application layer 404, and a NAN layer 406. NAN Device 408 is a non-power constrained device, a non-PD NAN Device, which includes a Service/Application layer 412 and a NAN layer 410.

As seen in FIG. 4, the Service/Application layer 412 of non-PD NAN Device 408 may first issue a Publish command 414 to the NAN layer to publish one or more of the non-PD NAN Device's services. The Service/Application layer 404 of PD NAN Device 402 may send a Subscribe command 416 to NAN layer 406. NAN layer 406 may execute the Subscribe command to generate an instance of a possible Subscribe Service Discovery Frame (SDF) 418 to non-PD NAN Device 408 to subscribe to one or more advertised NAN services. Thereafter, the NAN layer 406 may generate a Publish SDF message 420 that is sent to the NAN layer 410 of the non-PD NAN Device 408. The Service/Application layer 404 may then issue a Data Request command 422 to the NAN layer 406, this Data Request, according to some demonstrative embodiments, including a request to switch to a non-beacon-transmitter mode. The NAN layer 406, executing the Data Request command 422, may then generate a NAN Data Path Request NAF 424, using the reserved bit 3 in the capabilities field in the device capability attribute in the NAN Data Path Request NAF 424 to a first value, such as 1 or 0, to indicate that the PD NAN Device 402 wishes to switch to a non-Sync-frame transmitter role. Thereafter, NAN layer 410 of non-PD NAN Device 408 may provide a Data indication signal 426 to the Service/Application layer 412 informing the same of the request by PD NAN Device 402 to switch to a non-beacon-transmitter role. The Service/Application layer of non-PD NAN Device 408 may then to send a Data Response command 432 to the NAN layer 410 informing the same of a decision by non-PD NAN Device 408 regarding the NAN Data Path Request NAF 424. NAN layer 410 then may provide a NAN Data Path Response message 430 to the PD NAN Device 402 to indicate acceptance of the NAN Data Path Request (NAN Action Frame) NAF's request to switch the PD NAN Device 402 to a non-Sync-frame transmitter role. After receiving the NAN Data Path Response message 430, the NAN layer 406 may send a Data Confirm signal 428 to the Service/Application layer 404 of PD NAN Device 402, based on which PD NAN Device 402 may transition to a non-Sync-frame transmitter mode.

Referring still to FIG. 4, upon receiving the NAN Data Path Request frame 424, the non-PD NAN Device 408 may respond as follows as indicated in the NAN Data Path Response frame 430: it may accept either the request within the Data Path Request frame 424 or the request by the PD NAN Device to transition/switch to a non-Sync-frame transmitter role; it may accept both the request within the Data Path Request frame 424 and the request by the PD NAN Device to transition/switch to a non-Sync-frame transmitter role, or it may accept neither the request within the Data Path Request frame 424 nor the request by the PD NAN Device to transition/switch to a non-Sync-frame transmitter role.

Advantageously, some demonstrative embodiments allow PD NAN Devices to be power-efficient while still remaining synced to the TSF within their NAN Cluster.

According to a further embodiment, in order for a PD NAN Device to remain synced with respect to the TSF while at the same time being in a non-Sync-frame transmitter mode, a non-PD NAN Device that is in a Non-Master Non-Sync Role (NMNS non-PD NAN Device) may provide synchronization to a PD NAN Device by transmitting Sync beacons to the PD NAN Device, or to a plurality of PD NAN Devices including the PD NAN Device. According to one embodiment, the NMNS non-PD NAN Device may provide an indication to the PD NAN Device regarding the time slot or time slots within which it is to transmit the Sync beacons by providing information regarding the time slots. By way of example, the information to the PD NAN Device regarding the slots may be provided by the NMNS non-PD NAN Device via a NAN Availability Entry field in the NAN Data Path Response frame during a NAN Data Path set up process with the PD, such as during a NAN Data Path set up process as shown in FIG. 4. The time slot may include a particular Discovery Window (DW), such as, for example, DW0, or it may include any other DW. According to an alternative embodiment, the slot may be a non-DW slot. As a result, a PD NAN Device may remain awake only in slots where it expects to receive Sync frames such as synchronization beacon frames, thereby saving idle power consumption.

Advantageously, by allowing PD NAN Device 402 to listen for beacons in specific NAN time slots, some demonstrative embodiments allow PDs to remain synchronized while remaining power efficient.

Some demonstrative embodiments include an apparatus comprising a memory (such as memory 294 of FIG. 2), and processing circuitry coupled to the memory (such as processor 291 of FIG. 2), the circuitry configured to execute logic stored in the memory to cause a power-constrained (PD) Neighbor Awareness Networking (NAN) Device (such as AN device 220 of FIG. 2) to transition to a non-synchronization-frame (non-Sync-frame) mode based on a triggering event, the triggering event including at least one of: reception, by a NAN layer of the PD NAN Device, of transition instructions from a Service/Application layer of the PD NAN Device; or reception by the PD NAN Device of a management frame from a non-power-constrained NAN Device (non-PD NAN Device), the management frame including information on the PD NAN Device transitioning to a non-Sync-frame transmitter mode. The processing circuitry is further configured to execute the logic to synchronize to a Time Synchronization Function (TSF) timer of the NAN Cluster.

Some demonstrative embodiments include an apparatus comprising a memory (such as memory 294 of FIG. 2), and processing circuitry coupled to the memory (such as processor 291 of FIG. 2), the circuitry configured to execute logic stored in the memory to cause a Neighbor Awareness Networking (NAN) Device (such as AN device 220 of FIG. 2) to transmit a message indicating information regarding time slots within which a PD NAN Device is to receive a Synchronization frame (Sync frame); and to transmit synchronization beacon frames within the time slots to the PD NAN Device.

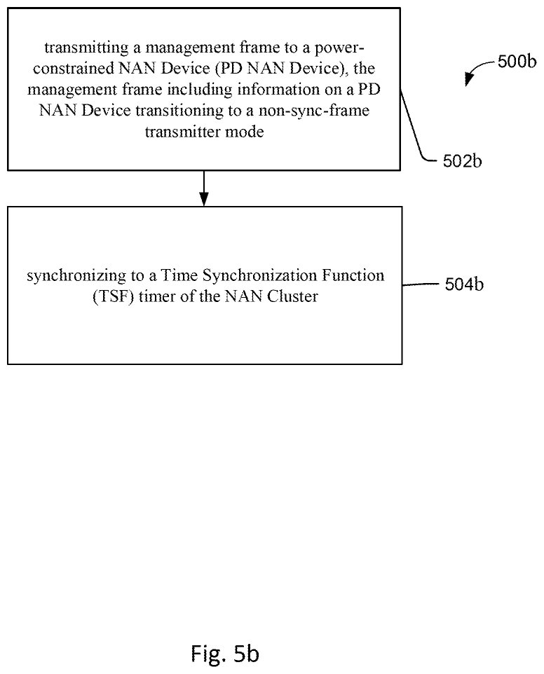

Referring next to FIG. 5a, a flow chart is depicted showing a method 500a according to an embodiment. At 502a, the method includes transitioning to a non-synchronization-frame (non-sync-frame) mode based on a triggering event, the triggering event including at least one of: reception by a NAN layer of a PD NAN Device of transition instructions from a Service/Application layer of the PD NAN Device; or reception by the PD NAN Device of a management frame from a non-power-constrained NAN Device (non-PD NAN Device), the management frame including information on the PD NAN Device transitioning to a non-sync-frame transmitter mode. At 504a, the method includes synchronizing to a Time Synchronization Function (TSF) timer of the NAN Cluster.

Referring to FIG. 5b, a flow chart is depicting showing a method 500b according to an embodiment. At 502b, the method includes transmitting a management frame to a power-constrained NAN Device (PD NAN Device), the management frame including information on a PD NAN Device transitioning to a non-sync-frame transmitter mode. At 504b, the method further includes synchronizing to a Time Synchronization Function (TSF) timer of the NAN Cluster.

FIG. 6 illustrates a block diagram of an example of a machine 600 or system upon which any one or more of the techniques (e.g., methodologies) discussed herein may be performed. In other embodiments, the machine 600 may operate as a standalone device, such as a standalone NAN Device, or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or a bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include one or more tangible computer-readable non-transitory storage media or modules including computer-executable instructions. The instructions may operate a number of components or mechanisms. Modules are tangible entities (e.g., hardware) capable of performing specified operations when operating. A module may include hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, the alphanumeric input device 612, and the UI navigation device 614 may be a touch screen display. The machine 600 may additionally include a storage device 616 (i.e., a drive unit), a signal generation device 618 (e.g., a speaker), a NAN Device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 616 may include a machine-readable medium 622 on which is stored one or more sets of data structures or instructions 624 (e.g., software) embodying or being utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The NAN Device 619 may carry out or perform any of the operations and processes (e.g., method/process 500a of FIG. 5a or method/process 500b of FIG. 5b) described and shown above.

It is understood that the above is only a subset of what the NAN Device 819 may be configured to perform and that other functions included throughout this disclosure may also be performed by the NAN Device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone Service (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product comprising a computer-readable storage medium, having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams and combinations of blocks in the block diagrams and flow diagrams can be implemented by special-purpose, hardware-based computer systems that perform the specified functions, elements, steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

In some demonstrative embodiments, the logic may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes an apparatus comprising a memory, and processing circuitry coupled to the memory, the processing circuitry configured to execute logic stored in the memory to cause a power-constrained Neighbor Awareness Networking (NAN) Device (PD NAN Device) within a NAN Cluster to transition to a non-synchronization-frame (non-Sync-frame) mode based on a triggering event, the triggering event including at least one of: reception, by a NAN layer of the PD NAN Device, of transition instructions from a Service/Application layer of the PD NAN Device; or reception by the PD NAN Device of a management frame from a non-power-constrained NAN Device (non-PD NAN Device), the management frame including information on the PD NAN Device transitioning to a non-Sync-frame transmitter mode. The processing circuitry is further to cause the PD NAN Device to synchronize to a Time Synchronization Function (TSF) timer of the NAN Cluster.

Example 2 includes the subject matter of Example 1, and optionally, wherein the processing circuitry is configured to execute the logic to cause the PD NAN Device to synchronize to the TSF timer of the NAN Cluster based on: a message by another NAN Device indicating information regarding time slots within which the PD NAN Device is to receive a Synchronization frame (Sync frame); and synchronization beacon frames transmitted within the time slots from said another NAN Device to the PD NAN Device.

Example 3 includes the subject matter of Example 2, and optionally, wherein the non-PD NAN Device is to be in a Non-Master Non-Sync (NMNS) role during transmission of the synchronization beacon frames.

Example 4 includes the subject matter of Example 2, and optionally, wherein the message includes a NAN Data Path Response frame by said another NAN Device, the NAN Data Path Response frame being in response to a NAN Data Path Request frame transmitted by the PD NAN Device to said another NAN Device.

Example 5 includes the subject matter of Example 4, and optionally, wherein the information regarding time slots is to be carried in a NAN Availability Entry field of the NAN Data Path Response frame.

Example 6 includes the subject matter of Example 1, and optionally, wherein: the processing circuitry is configured to execute the logic to cause the PD NAN Device to transmit a NAN Data Path Request frame to the non-PD NAN Device, the NAN Data Path Request frame including a request for the PD NAN Device to transition to a non-Sync-frame transmitter mode; and the management frame includes a NAN Data Path Response frame from the non-PD NAN Device in response to the NAN Data Path Request frame.

Example 7 includes the subject matter of Example 6, and optionally, wherein the request is to be indicated by information carried in one or more bits in an attribute or field of the NAN Data Path Request frame.

Example 8 includes the subject matter of Example 7, and optionally, wherein the one or more bits include reserved bit 3 in a Capabilities field in a Device Capability Attribute of the NAN Data Path Request frame.

Example 9 includes the subject matter of Example 6, and optionally, wherein the NAN Data Path Request frame includes information regarding one or more system configuration parameters of the PD NAN Device, the one or more system configuration parameters including at least one of device capabilities, battery power level or rank.

Example 10 includes the subject matter of Example 9, and optionally, wherein the information regarding the one or more system configuration parameters is carried in one of: reserved bits 4-7 in a Capabilities field of a Capability attribute of the PD NAN Device or a Remaining Energy Level field.

Example 11 includes the subject matter of Example 6, and optionally, wherein the information on the PD NAN Device transitioning to a non-Sync-frame transmitter mode includes one of: acceptance of one of the request for the PD NAN Device to transition to a non-Sync-frame transmitter mode or a request within the NAN Data Path Request frame to set up a data path; acceptance of the request for the PD NAN Device to transition to a non-Sync-frame transmitter mode and acceptance of the request within the NAN Data Path Request frame to set up a data path; or rejection of both the request for the PD NAN Device to transition to a non-Sync-frame transmitter mode and the request within the NAN Data Path Request frame to set up a data path.

Example 12 includes the subject matter of Example 1, and optionally, wherein the processing circuitry is configured to execute the logic to cause the PD NAN Device to determine one or more system parameters regarding itself, the one or more system parameters including at least a battery energy level, a device capability, or an application configuration, the transition instructions being based on the one or more system parameters.

Example 13 includes the subject matter of Example 1, and optionally, wherein the transition instructions are based on the NAN Device becoming a Sleepy Edge Device or child device in a layer-3 topology.

Example 14 includes the subject matter of Example 1, and optionally, wherein the information in the management frame on the PD NAN Device transitioning is contained in a bit in a field of the management frame.

Example 15 includes the subject matter of Example 1, and optionally, further including a radio coupled to the processing circuitry.

Example 16 includes the subject matter of Example 15, and optionally, further including an antenna coupled to the radio.

Example 17 includes a method to be performed at a power constrained (PD) Neighbor Awareness Networking (NAN) Device in a NAN Cluster, the method comprising transitioning to a non-synchronization-frame (non-Sync-frame) mode based on a triggering event, the triggering event including at least one of: reception, by a NAN layer of the PD NAN Device, of transition instructions from a Service/Application layer of the PD NAN Device; or reception by the PD NAN Device of a management frame from a non-power-constrained NAN Device (non-PD NAN Device), the management frame including information on the PD NAN Device transitioning to a non-Sync-frame transmitter mode. The method further includes synchronizing to a Time Synchronization Function (TSF) timer of the NAN Cluster.

Example 18 includes the subject matter of Example 17, and optionally, wherein synchronizing to the TSF timer of the NAN Cluster based on: a message by another NAN Device indicating information regarding time slots within which the PD NAN Device is to receive a Synchronization frame (Sync frame); and synchronization beacon frames transmitted within the time slots from said another NAN Device to the PD NAN Device.

Example 19 includes the subject matter of Example 18, and optionally, wherein the non-PD NAN Device is to be in a Non-Master Non-Sync (NMNS) role during transmission of the synchronization beacon frames.

Example 20 includes the subject matter of Example 18, and optionally, wherein the message includes a NAN Data Path Response frame by said another NAN Device, the NAN Data Path Response frame being in response to a NAN Data Path Request frame transmitted by the PD NAN Device to said another NAN Device.

Example 21 includes the subject matter of Example 20, and optionally, wherein the information regarding time slots is to be carried in a NAN Availability Entry field of the NAN Data Path Response frame.

Example 22 includes the subject matter of Example 17, and optionally, further including transmitting a NAN Data Path Request frame to the non-PD NAN Device, the NAN Data Path Request frame including a request for the PD NAN Device to transition to a non-Sync-frame transmitter mode, the management frame including a NAN Data Path Response frame from the non-PD NAN Device in response to the NAN Data Path Request frame.

Example 23 includes the subject matter of Example 22, and optionally, wherein the request is to be indicated by information carried in one or more bits in an attribute or field of the NAN Data Path Request frame.

Example 24 includes the subject matter of Example 23, and optionally, wherein the one or more bits include reserved bit 3 in a Capabilities field in a Device Capability Attribute of the NAN Data Path Request frame.

Example 25 includes the subject matter of Example 22, and optionally, wherein the NAN Data Path Request frame includes information regarding one or more system configuration parameters of the PD NAN Device, the one or more system configuration parameters including at least one of device capabilities, battery power level or rank.

Example 26 includes the subject matter of Example 25, and optionally, wherein the information regarding the one or more system configuration parameters is carried in one of: reserved bits 4-7 in a Capabilities field of a Capability attribute of the PD NAN Device or a Remaining Energy Level field.

Example 27 includes the subject matter of Example 22, and optionally, wherein the information on the PD NAN Device transitioning to a non-Sync-frame transmitter mode includes one of: acceptance of one of the request for the PD NAN Device to transition to a non-Sync-frame transmitter mode or a request within the NAN Data Path Request frame to set up a data path; acceptance of the request for the PD NAN Device to transition to a non-Sync-frame transmitter mode and acceptance of the request within the NAN Data Path Request frame to set up a data path; or rejection of both the request for the PD NAN Device to transition to a non-Sync-frame transmitter mode and the request within the NAN Data Path Request frame to set up a data path.

Example 28 includes the subject matter of Example 17, and optionally, further including determining one or more system parameters regarding itself, the one or more system parameters including at least a battery energy level, a device capability, or an application configuration, the transition instructions being based on the one or more system parameters.

Example 29 includes the subject matter of Example 17, and optionally, wherein the transition instructions are based on the NAN Device becoming a Sleepy Edge Device or child device in a layer-3 topology.

Example 30 includes the subject matter of Example 17, and optionally, wherein the information in the management frame on the PD NAN Device transitioning is contained in a bit in a field of the management frame.

Example 31 includes a product including one or more tangible computer-readable non-transitory storage media comprising computer-executable instructions operable to, when executed by at least one computer processor, enable the at least one computer processor to implement operations at power-constrained (PD) a Neighbor Awareness Networking (NAN) device in a NAN cluster, the operations comprising transitioning to a non-synchronization-frame (non-Sync-frame) mode based on a triggering event, the triggering event including at least one of: reception, by a NAN layer of the PD NAN Device, of transition instructions from a Service/Application layer of the PD NAN Device; or reception by the PD NAN Device of a management frame from a non-power-constrained NAN Device (non-PD NAN Device), the management frame including information on the PD NAN Device transitioning to a non-Sync-frame transmitter mode. The operations further include synchronizing to a Time Synchronization Function (TSF) timer of the NAN Cluster.

Example 32 includes the subject matter of Example 31, and optionally, wherein the operations further comprise synchronizing to the TSF timer of the NAN Cluster based on: a message by another NAN Device indicating information regarding time slots within which the PD NAN Device is to receive a Synchronization frame (Sync frame); and synchronization beacon frames transmitted within the time slots from said another NAN Device to the PD NAN Device.

Example 33 includes the subject matter of Example 32, and optionally, wherein the non-PD NAN Device is to be in a Non-Master Non-Sync (NMNS) role during transmission of the synchronization beacon frames.

Example 34 includes the subject matter of Example 32, and optionally, wherein the message includes a NAN Data Path Response frame by said another NAN Device, the NAN Data Path Response frame being in response to a NAN Data Path Request frame transmitted by the PD NAN Device to said another NAN Device.

Example 35 includes the subject matter of Example 34, and optionally, wherein the information regarding time slots is to be carried in a NAN Availability Entry field of the NAN Data Path Response frame.

Example 36 includes the subject matter of Example 31, and optionally, wherein: the operations further include transmitting a NAN Data Path Request frame to the non-PD NAN Device, the NAN Data Path Request frame including a request for the PD NAN Device to transition to a non-Sync-frame transmitter mode; and the management frame includes a NAN Data Path Response frame from the non-PD NAN Device in response to the NAN Data Path Request frame.

Example 37 includes the subject matter of Example 36, and optionally, wherein the request is to be indicated by information carried in one or more bits in an attribute or field of the NAN Data Path Request frame.

Example 38 includes the subject matter of Example 37, and optionally, wherein the one or more bits include reserved bit 3 in a Capabilities field in a Device Capability Attribute of the NAN Data Path Request frame.

Example 39 includes the subject matter of Example 36, and optionally, wherein the NAN Data Path Request frame includes information regarding one or more system configuration parameters of the PD NAN Device, the one or more system configuration parameters including at least one of device capabilities, battery power level or rank.

Example 40 includes the subject matter of Example 39, and optionally, wherein the information regarding the one or more system configuration parameters is carried in one of: reserved bits 4-7 in a Capabilities field of a Capability attribute of the PD NAN Device or a Remaining Energy Level field.

Example 41 includes the subject matter of Example 36, and optionally, wherein the information on the PD NAN Device transitioning to a non-Sync-frame transmitter mode includes one of: acceptance of one of the request for the PD NAN Device to transition to a non-Sync-frame transmitter mode or a request within the NAN Data Path Request frame to set up a data path; acceptance of the request for the PD NAN Device to transition to a non-Sync-frame transmitter mode and acceptance of the request within the NAN Data Path Request frame to set up a data path; or rejection of both the request for the PD NAN Device to transition to a non-Sync-frame transmitter mode and the request within the NAN Data Path Request frame to set up a data path.

Example 42 includes the subject matter of Example 31, and optionally, wherein the operations further include determining one or more system parameters regarding itself, the one or more system parameters including at least a battery energy level, a device capability, or an application configuration, the transition instructions being based on the one or more system parameters.

Example 43 includes the subject matter of Example 31, and optionally, wherein the transition instructions are based on the NAN Device becoming a Sleepy Edge Device or child device in a layer-3 topology.

Example 44 includes the subject matter of Example 31, and optionally, wherein the information in the management frame on the PD NAN Device transitioning is contained in a bit in a field of the management frame.

Example 45 includes an apparatus of a power-constrained Neighbor Awareness Networking (NAN) Device (PD NAN Device) within a NAN Cluster, the apparatus including: means for transitioning to a non-synchronization-frame (non-Sync-frame) mode based on a triggering event, the triggering event including at least one of: reception, by a NAN layer of the PD NAN Device, of transition instructions from a Service/Application layer of the PD NAN Device; or reception by the PD NAN Device of a management frame from a non-power-constrained NAN Device (non-PD NAN Device), the management frame including information on the PD NAN Device transitioning to a non-Sync-frame transmitter mode; and means for synchronizing to a Time Synchronization Function (TSF) timer of the NAN Cluster.

Example 46 includes the subject matter of Example 45, and optionally, wherein synchronizing to the TSF timer of the NAN Cluster based on: a message by another NAN Device indicating information regarding time slots within which the PD NAN Device is to receive a Synchronization frame (Sync frame); and synchronization beacon frames transmitted within the time slots from said another NAN Device to the PD NAN Device.

Example 47 includes the subject matter of Example 46, and optionally, further including means for transmitting a NAN Data Path Request frame to the non-PD NAN Device, the NAN Data Path Request frame including a request for the PD NAN Device to transition to a non-Sync-frame transmitter mode, the management frame including a NAN Data Path Response frame from the non-PD NAN Device in response to the NAN Data Path Request frame.

Example 48 includes an apparatus comprising a memory, and processing circuitry coupled to the memory, the processing circuitry configured to execute logic stored in the memory to cause a non-power-constrained Neighbor Awareness Networking (NAN) Device (non-PD NAN Device) within a NAN Cluster to: transmit a management frame to a power-constrained NAN Device (PD NAN Device), the management frame including information on the PD NAN Device transitioning to a non-Sync-frame transmitter mode; and synchronize to a Time Synchronization Function (TSF) timer of the NAN Cluster.

Example 49 includes the subject matter of Example 48, and optionally, wherein: the processing circuitry is configured to execute the logic to cause the non-PD NAN Device to receive a NAN Data Path Request frame from the PD NAN Device, the NAN Data Path Request frame including a request for the PD NAN Device to transition to a non-Sync-frame transmitter mode; and the management frame includes a NAN Data Path Response frame from the non-PD NAN Device in response to the NAN Data Path Request frame.

Example 50 includes the subject matter of Example 49, and optionally, wherein the request is to be indicated by information carried in one or more bits in an attribute or field of the NAN Data Path Request frame.

Example 51 includes the subject matter of Example 50, and optionally, wherein the one or more bits include reserved bit 3 in a Capabilities field in a Device Capability Attribute of the NAN Data Path Request frame.

Example 52 includes the subject matter of Example 49, and optionally, wherein the NAN Data Path Request frame includes information regarding one or more system configuration parameters of the PD NAN Device, the one or more system configuration parameters including at least one of device capabilities, battery power level or rank.

Example 53 includes the subject matter of Example 52, and optionally, wherein the information regarding the one or more system configuration parameters is carried in one of: reserved bits 4-7 in a Capabilities field of a Capability attribute of the PD NAN Device or a Remaining Energy Level field.

Example 54 includes the subject matter of Example 49, and optionally, wherein the information on the PD NAN Device transitioning to a non-Sync-frame transmitter mode includes one of: acceptance of one of the request for the PD NAN Device to transition to a non-Sync-frame transmitter mode or a request within the NAN Data Path Request frame to set up a data path; acceptance of the request for the PD NAN Device to transition to a non-Sync-frame transmitter mode and acceptance of the request within the NAN Data Path Request frame to set up a data path; or rejection of both the request for the PD NAN Device to transition to a non-Sync-frame transmitter mode and the request within the NAN Data Path Request frame to set up a data path.

Example 55 includes the subject matter of Example 48, and optionally, wherein the information in the management frame on the PD NAN Device transitioning is contained in a bit in a field of the management frame.

Example 56 includes the subject matter of Example 48, and optionally, further including a radio coupled to the processing circuitry.

Example 57 includes the subject matter of Example 56, and optionally, further including an antenna coupled to the radio.

Example 58 includes a method of operating a non-power-constrained Neighbor Awareness Networking (NAN) Device (non-PD NAN Device) within a NAN Cluster, the method including: transmitting a management frame to a power-constrained NAN Device (PD NAN Device), the management frame including information on the PD NAN Device transitioning to a non-Sync-frame transmitter mode; and synchronizing to a Time Synchronization Function (TSF) timer of the NAN Cluster.

Example 59 includes the subject matter of Example 58, and optionally, further including receiving a NAN Data Path Request frame from the PD NAN Device, the NAN Data Path Request frame including a request for the PD NAN Device to transition to a non-Sync-frame transmitter mode, wherein the management frame includes a NAN Data Path Response frame from the non-PD NAN Device in response to the NAN Data Path Request frame.

Example 60 includes the subject matter of Example 59, and optionally, wherein the request is to be indicated by information carried in one or more bits in an attribute or field of the NAN Data Path Request frame.

Example 61 includes the subject matter of Example 60, and optionally, wherein the one or more bits include reserved bit 3 in a Capabilities field in a Device Capability Attribute of the NAN Data Path Request frame.

Example 62 includes the subject matter of Example 59, and optionally, wherein the NAN Data Path Request frame includes information regarding one or more system configuration parameters of the PD NAN Device, the one or more system configuration parameters including at least one of device capabilities, battery power level or rank.

Example 63 includes the subject matter of Example 62, and optionally, wherein the information regarding the one or more system configuration parameters is carried in one of: reserved bits 4-7 in a Capabilities field of a Capability attribute of the PD NAN Device or a Remaining Energy Level field.

Example 64 includes the subject matter of Example 59, and optionally, wherein the information on the PD NAN Device transitioning to a non-Sync-frame transmitter mode includes one of: acceptance of one of the request for the PD NAN Device to transition to a non-Sync-frame transmitter mode or a request within the NAN Data Path Request frame to set up a data path; acceptance of the request for the PD NAN Device to transition to a non-Sync-frame transmitter mode and acceptance of the request within the NAN Data Path Request frame to set up a data path; or rejection of both the request for the PD NAN Device to transition to a non-Sync-frame transmitter mode and the request within the NAN Data Path Request frame to set up a data path.

Example 65 includes the subject matter of Example 58, and optionally, wherein the information in the management frame on the PD NAN Device transitioning is contained in a bit in a field of the management frame.

Example 66 includes a product including one or more tangible computer-readable non-transitory storage media comprising computer-executable instructions operable to, when executed by at least one computer processor, enable the at least one computer processor to implement operations at a non-power constrained (non-PD) Neighbor Awareness Networking (NAN) device in a NAN Cluster, the operations comprising: transmitting a management frame to a power-constrained NAN Device (PD NAN Device), the management frame including information on the PD NAN Device transitioning to a non-Sync-frame transmitter mode; and synchronizing to a Time Synchronization Function (TSF) timer of the NAN Cluster.

Example 67 includes the subject matter of Example 66, and optionally, the operations further including receiving a NAN Data Path Request frame from the PD NAN Device, the NAN Data Path Request frame including a request for the PD NAN Device to transition to a non-Sync-frame transmitter mode, wherein the management frame includes a NAN Data Path Response frame from the non-PD NAN Device in response to the NAN Data Path Request frame.

Example 68 includes the subject matter of Example 67, and optionally, wherein the request is to be indicated by information carried in one or more bits in an attribute or field of the NAN Data Path Request frame.

Example 69 includes the subject matter of Example 68, and optionally, wherein the one or more bits include reserved bit 3 in a Capabilities field in a Device Capability Attribute of the NAN Data Path Request frame.

Example 70 includes the subject matter of Example 67, and optionally, wherein the NAN Data Path Request frame includes information regarding one or more system configuration parameters of the PD NAN Device, the one or more system configuration parameters including at least one of device capabilities, battery power level or rank.

Example 71 includes the subject matter of Example 70, and optionally, wherein the information regarding the one or more system configuration parameters is carried in one of: reserved bits 4-7 in a Capabilities field of a Capability attribute of the PD NAN Device or a Remaining Energy Level field.

Example 72 includes the subject matter of Example 67, and optionally, wherein the information on the PD NAN Device transitioning to a non-Sync-frame transmitter mode includes one of: acceptance of one of the request for the PD NAN Device to transition to a non-Sync-frame transmitter mode or a request within the NAN Data Path Request frame to set up a data path; acceptance of the request for the PD NAN Device to transition to a non-Sync-frame transmitter mode and acceptance of the request within the NAN Data Path Request frame to set up a data path; or rejection of both the request for the PD NAN Device to transition to a non-Sync-frame transmitter mode and the request within the NAN Data Path Request frame to set up a data path.

Example 73 includes the subject matter of Example 66, and optionally, wherein the information in the management frame on the PD NAN Device transitioning is contained in a bit in a field of the management frame.

Example 74 includes a Machine-readable storage including machine-readable instructions which, when executed, are to implement a method or realize an apparatus as set forth in any preceding Example.

Example 75 includes a machine-readable medium including code, which, when executed, is to cause a machine to perform the method of any one of Examples 17-30 and 58-65.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1. An apparatus comprising a memory, and processing circuitry coupled to the memory, the processing circuitry configured to execute logic stored in the memory to cause a power-constrained Neighbor Awareness Networking (NAN) Device (PD NAN Device) within a NAN Cluster to:
transition to a non-synchronization-frame (non-Sync-frame) mode based on a triggering event, the triggering event including at least one of:
reception, by a NAN layer of the PD NAN Device, of transition instructions from a Service/Application layer of the PD NAN Device; or
reception by the PD NAN Device of a management frame from a non-power-constrained NAN Device (non-PD NAN Device), the management frame including information on the PD NAN Device transitioning to a non-Sync-frame transmitter mode; and
synchronize to a Time Synchronization Function (TSF) timer of the NAN Cluster.

2. The apparatus of claim 1, wherein the processing circuitry is configured to execute the logic to cause the PD NAN Device to synchronize to the TSF timer of the NAN Cluster based on:
a message by another NAN Device indicating information regarding time slots within which the PD NAN Device is to receive a Synchronization frame (Sync frame); and
synchronization beacon frames transmitted within the time slots from said another NAN Device to the PD NAN Device.

3. The apparatus of claim 2, wherein the message includes a NAN Data Path Response frame by said another NAN Device, the NAN Data Path Response frame being in response to a NAN Data Path Request frame transmitted by the PD NAN Device to said another NAN Device.

4. The apparatus of claim 1, wherein:
the processing circuitry is configured to execute the logic to cause the PD NAN Device to transmit a NAN Data Path Request frame to the non-PD NAN Device, the NAN Data Path Request frame including a request for the PD NAN Device to transition to a non-Sync-frame transmitter mode; and
the management frame includes a NAN Data Path Response frame from the non-PD NAN Device in response to the NAN Data Path Request frame.

5. The apparatus of claim 4, wherein:
the request is to be indicated by information carried in one or more bits in an attribute or field of the NAN Data Path Request frame; and
the one or more bits include reserved bit 3 in a Capabilities field in a Device Capability Attribute of the NAN Data Path Request frame.

6. The apparatus of claim 4, wherein the NAN Data Path Request frame includes information regarding one or more system configuration parameters of the PD NAN Device, the one or more system configuration parameters including at least one of device capabilities, battery power level or rank.

7. The apparatus of claim 6, wherein the information regarding the one or more system configuration parameters is carried in one of: reserved bits 4-7 in a Capabilities field of a Capability attribute of the PD NAN Device or a Remaining Energy Level field.

8. The apparatus of claim 4, wherein the information on the PD NAN Device transitioning to a non-Sync-frame transmitter mode includes one of:
acceptance of one of the request for the PD NAN Device to transition to a non-Sync-frame transmitter mode or a request within the NAN Data Path Request frame to set up a data path;
acceptance of the request for the PD NAN Device to transition to a non-Sync-frame transmitter mode and acceptance of the request within the NAN Data Path Request frame to set up a data path; or
rejection of both the request for the PD NAN Device to transition to a non-Sync-frame transmitter mode and the request within the NAN Data Path Request frame to set up a data path.

9. The apparatus of claim 1, wherein the processing circuitry is configured to execute the logic to cause the PD NAN Device to determine one or more system parameters regarding itself, the one or more system parameters including at least a battery energy level, a device capability, or an application configuration, the transition instructions being based on the one or more system parameters.

10. The apparatus of claim 1, further including a radio coupled to the processing circuitry.

11. The apparatus of claim 10, further including an antenna coupled to the radio.

12.-25. (canceled)

26. A product including one or more tangible computer-readable non-transitory storage media comprising computer-executable instructions operable to, when executed by at least one computer processor, enable the at least one computer processor to implement operations at a power-constrained (PD) Neighbor Awareness Networking (NAN) device in a NAN Cluster, the operations comprising:
transitioning to a non-synchronization-frame (non-Sync-frame) mode based on a triggering event, the triggering event including at least one of:
reception, by a NAN layer of the PD NAN Device, of transition instructions from a Service/Application layer of the PD NAN Device;
reception by the PD NAN Device of a management frame from a non-power-constrained NAN Device (non-PD NAN Device), the management frame including information on the PD NAN Device transitioning to a non-Sync-frame transmitter mode; and
synchronizing to a Time Synchronization Function (TSF) timer of the NAN Cluster.

27. The product of claim 26, wherein the operations further comprise synchronizing to the TSF timer of the NAN Cluster based on:
a message by another NAN Device indicating information regarding time slots within which the PD NAN Device is to receive a Synchronization frame (Sync frame); and
synchronization beacon frames transmitted within the time slots from said another NAN Device to the PD NAN Device.

28. The product of claim 27, wherein the message includes a NAN Data Path Response frame by said another NAN Device, the NAN Data Path Response frame being in response to a NAN Data Path Request frame transmitted by the PD NAN Device to said another NAN Device.

29. The product of claim 27, wherein the message is in a NAN Data Path Response frame, and the information regarding time slots is to be carried in a NAN Availability Entry field of the NAN Data Path Response frame.

30. The product of claim 26, wherein:
the operations further include transmitting a NAN Data Path Request frame to the non-PD NAN Device, the NAN Data Path Request frame including a request for the PD NAN Device to transition to a non-Sync-frame transmitter mode; and
the management frame includes a NAN Data Path Response frame from the non-PD NAN Device in response to the NAN Data Path Request frame.

31. The product of claim 30, wherein the request is to be indicated by information carried in one or more bits in an attribute or field of the NAN Data Path Request frame.

32. The product of claim 31, wherein the one or more bits include reserved bit 3 in a Capabilities field in a Device Capability Attribute of the NAN Data Path Request frame.

33. The product of claim 30, wherein the NAN Data Path Request frame includes information regarding one or more system configuration parameters of the PD NAN Device, the one or more system configuration parameters including at least one of device capabilities, battery power level or rank.

34. The product of claim 33, wherein the information regarding the one or more system configuration parameters is carried in one of: reserved bits 4-7 in a Capabilities field of a Capability attribute of the PD NAN Device or a Remaining Energy Level field.

35. The product of claim 30, wherein the information on the PD NAN Device transitioning to a non-Sync-frame transmitter mode includes one of:
acceptance of one of the request for the PD NAN Device to transition to a non-Sync-frame transmitter mode or a request within the NAN Data Path Request frame to set up a data path;
acceptance of the request for the PD NAN Device to transition to a non-Sync-frame transmitter mode and acceptance of the request within the NAN Data Path Request frame to set up a data path; or
rejection of both the request for the PD NAN Device to transition to a non-Sync-frame transmitter mode and the request within the NAN Data Path Request frame to set up a data path.

36. The product of claim 26, wherein the operations further include determining one or more system parameters, the one or more system parameters including at least a battery energy level, a device capability, or an application configuration, the transition instructions being based on the one or more system parameters.

37. An apparatus of a power-constrained Neighbor Awareness Networking (NAN) Device (PD NAN Device) within a NAN Cluster, the apparatus including:
means for transitioning to a non-synchronization-frame (non-Sync-frame) mode based on a triggering event, the triggering event including at least one of:
reception, by a NAN layer of the PD NAN Device, of transition instructions from a Service/Application layer of the PD NAN Device; or
reception by the PD NAN Device of a management frame from a non-power-constrained NAN Device (non-PD NAN Device), the management frame including information on the PD NAN Device transitioning to a non-Sync-frame transmitter mode; and
means for synchronizing to a Time Synchronization Function (TSF) timer of the NAN Cluster.

38. The apparatus of claim 37, wherein synchronizing to the TSF timer of the NAN Cluster based on:
a message by another NAN Device indicating information regarding time slots within which the PD NAN Device is to receive a Synchronization frame (Sync frame); and
synchronization beacon frames transmitted within the time slots from said another NAN Device to the PD NAN Device.

39. The apparatus of claim 38, further including means for transmitting a NAN Data Path Request frame to the non-PD NAN Device, the NAN Data Path Request frame including a request for the PD NAN Device to transition to a non-Sync-frame transmitter mode, the management frame including a NAN Data Path Response frame from the non-PD NAN Device in response to the NAN Data Path Request frame.
